(19) United States
(12) Patent Application Publication
(10) Pub. No.: US 2025/0167871 A1
(43) Pub. Date: May 22, 2025

(54) UE-SIDE BEAM SELECTION PROCEDURE

(71) Applicant: Telefonaktiebolaget LM Ericsson (publ), Stockholm (SE)

(72) Inventors: Sven PETERSSON, Sävedalen (SE); Fredrik ATHLEY, Västra Frölunda (SE); Andreas NILSSON, Göteborg (SE)

(73) Assignee: Telefonaktiebolaget LM Ericsson (publ), Stockholm (SE)

(21) Appl. No.: 18/840,398

(22) PCT Filed: Feb. 22, 2022
(86) PCT No.: PCT/EP2022/054297

§ 371 Date: Aug. 21, 2024

(51) Int. Cl. H04B 7/08; H04B 7/06; H04B 17/318

(52) U.S. Cl. CPC H04B 7/088; H04B 7/0626; H04B 7/066; H04B 17/328

(57) ABSTRACT

There is provided a UE-side beam selection procedure. According to the UE-side beam selection procedure, a user equipment, based on an estimated reliability value of received downlink reference signals and the movement of the user equipment, determines how to filter the received downlink reference signals measurements when determining which candidate beam to use for communication with a network node.

### TECHNICAL FIELD

Embodiments presented herein relate to a method, a user equipment, a computer program, and a computer program product for performing a user equipment-side beam selection procedure.

### BACKGROUND

For example, for future generations of mobile communications networks, frequency bands at many different carrier frequencies could be needed. For example, low such frequency bands could be needed to achieve sufficient network coverage for wireless devices and higher frequency bands (e.g. at millimeter wavelengths (mmW), i.e. near and above 30 GHz, or even frequency bands in the THz, or at least sub-THz region) could be needed to reach required network capacity. In general terms, at high frequencies the propagation properties of the radio channel are more challenging and beamforming both at the network node of the network and at the wireless devices might be required to reach a sufficient link budget.

FIG. 1 is a schematic diagram illustrating a communication network 100 according to an example. The communication network 100 could be a fourth generation (4G) telecommunications network, a fifth generation (5G) telecommunications network, or any evolvement thereof, and support any 3rd generation partnership project (3GPP) telecommunications standard, where applicable.

The communication network 100 comprises a network node 140 configured to provide network access to user equipment (UE), as represented by UE 200, in a radio access network 110. The radio access network 110 is operatively connected to a core network 120. The core network 120 is in turn operatively connected to a service network 130, such as the Internet. The UE 200 is thereby enabled to, via the network node 140, access services of, and exchange data with, the service network 130.

The network node 140 comprises, is collocated with, is integrated with, or is in operational communications with, a transmission and reception point (TRP). The network node 140 (via its TRP) and the UE 200 is configured to communicate with each other over wireless links 190 in a radio propagation channel, or environment. Examples of network nodes 200 are radio access network nodes, radio base stations, base transceiver stations, Node Bs (NBs), evolved Node Bs (eNBs), gNBs, access points, access nodes, and integrated access and backhaul (JAB) nodes. Examples of UEs 300 are wireless devices, mobile stations, mobile phones, handsets, wireless local loop phones, smartphones, laptop computers, tablet computers, network equipped sensors, network equipped vehicles, and so-called Internet of Things devices.

Due to severe propagation losses, the radio propagation channel in such higher frequency bands usually have a few useful paths, or even just the line of sight (LOS) path, for facilitating reliable communication between the network node 140 at the network-side and the UE 200 at the user-side. Large antenna arrays are then used to provide array gains large enough to overcome the propagation losses. However, large antenna arrays operating at higher frequency bands generally have only few radio-frequency (RF) chains due to hardware complexity. This allows only for the use of analog or hybrid beamforming. In this case, beams are narrow and time multiplexed, yielding a very large number of beams to be managed at both the network-side and the user-side.

In this context, beam management as used in new radio (NR) telecommunication systems, also referred to as 5G telecommunication systems, includes some procedures that are mainly responsible for i) establishing an initial beam pair link (BPL) between the network node 140 and the UE 200, and ii) maintaining the BPL with good quality. A beam selection procedure can then be performed to improve link quality, for example by finding BPLs with beams (at both the network node 140 and the UE 200) that provide higher array gain and/or better spatial alignment than the initial BPL. However, in such higher frequency bands, large bandwidth and high throughput make session time short. Therefore, the beam selection procedure must be fast to be useful. This will be further elaborated on with reference to FIG. 2. FIG. 2 schematically illustrates a beam management procedure, which is a typical example of a legacy NR beam management procedure, consisting of three sub-procedures, referred to as P-1, P-2, and P-3 sub-procedures. These three sub-procedures will now be disclosed in more detail.

One main purpose of the P-1 sub-procedure is for the network node 140 to find a coarse direction towards the UE 200 by transmitting reference signals in wide, but narrower than sector, beams that are swept over the whole angular sector. The network node 140 is expected to, for the P-1 sub-procedure, utilize beams, according to a spatial beam pattern 150a, with rather large beam widths. During the P-1 sub-procedure, the reference signals are typically transmitted periodically and are shared between all UEs 200 served by the network node 140 in the radio access network 110. The UE 200 uses a wide, or even omni-directional beam for receiving the reference signals during the P-1 sub-procedure, according to a spatial beam pattern 172a. The reference signals might be periodically transmitted channel state information reference signals (CSI-RS) or synchronization signal blocks (SSB). The UE 200 might then to the network node 140 report the N≥1 best beams and their corresponding quality values, such as reference signal received power (RSRP) values. The beam reporting from the UE 200 to the network node 140 might be performed rather seldom (in order to save overhead) and can be either periodic, semi-persistent or aperiodic.

One main purpose of the P-2 sub-procedure is to refine the beam selection at the network node 140 by the network node 140 transmitting reference signals whilst performing a new beam sweep with more narrow directional beams, according to a spatial beam pattern 160a, than those beams used during the P-1 sub-procedure, where the new beam sweep is performed around the coarse direction, or beam, reported during the P-1 sub-procedure. During the P-2 sub-procedure, the UE 200 typically uses the same beam as during the P-1 sub-procedure, according to a spatial beam pattern 172a. The UE 200 might then to the network node 140 report the N≥1 best beams and their corresponding quality values, such as reference signal received power (RSRP) values. One P-2 sub-procedure might be performed per each UE 200 or per each group of UEs 200. The reference signals might be aperiodically or semi-persistently transmitted CSI-RS. The P-2 sub-procedure might be performed more frequently than the P-1 sub-procedure in order to track movements of the UE 200 and/or changes in the radio propagation environment.

One main purpose of the P-3 sub-procedure is for UEs 200 utilizing analog beamforming, or digital wideband (time domain beamformed) beamforming, to find a best UE-side beam. The P-3 sub-procedure might therefore be referred to as a UE-side beam selection procedure. During the P-3 sub-procedure, the reference signals are transmitted, according to a spatial beam pattern 162a, in the best reported beam of the P-2 sub-procedure whilst the UE 200 performs a beam sweep, according to a spatial beam pattern 180a. The P-3 sub-procedure might be performed at least as frequently as the P-2 sub-procedure in order to enable the UE 200 to compensate for blocking, and/or rotation.

The beam as selected by the network node 140 from the beam selection at the network node 140 in the P-2 sub-procedure and the beam as selected by the UE 200 from the beam selection at the UE 200 in the P-3 sub-procedure thus defines the BPL. In this respect, the RSRP for a given BPL can vary substantially (in order of 5 dB) without any macro mobility updates of the UE 200. One example of this is illustrated in FIG. 3, where the macro mobility parameters are updated every slot (solid line) or every 80 slots (dotted line). It is noted that 80 slots correspond to 10 ms at 120 kHz sub-carrier spacing. By observing the dotted line, within two vertical lines (i.e., within a time period of 80 slots where no macro mobility parameters have been updated), it can be seen that due to fast fading effects, the path gain measurements (which is equivalent to RSRP measurements) can vary up to 5 dB. Since the BPL is expected to be updated less frequently in time than so, RSRP measurement impacted by fast fading might lead to improper BPL selection, depending on if e.g. the RSRP measurement for a certain BPL is measured in a fast fading dip or a fast fading top, the UE 200 might select a different beam, resulting in different BPLs.

Hence, there is still a need for an improved beam selection procedure.

### SUMMARY

An object of embodiments herein is to provide a UE-side beam selection procedure that does not suffer from the issues disclosed above.

According to a first aspect there is presented a method for performing a UE-side beam selection procedure. The method is performed by a user equipment. The UE-side beam selection procedure comprises receiving, in candidate beam k, at least one downlink reference signal from a network node. Each of the at least one downlink reference signal is composed of orthogonal frequency-division multiplexing symbols. The UE-side beam selection procedure comprises associating the received at least one downlink reference signal with a reliability value. The UE-side beam selection procedure comprises determining, as a function of the reliability value and movement of the user equipment when receiving the at least one downlink reference signal, filter settings of a filter to be applied to the at least one received downlink reference signal. The UE-side beam selection procedure comprises filtering the received at least one downlink reference signal according to the determined filter settings. The UE-side beam selection procedure comprises performing reference signal received power measurements on the filtered at least one received downlink reference signal. The UE-side beam selection procedure comprises, once the above steps have been performed for each candidate beam k in a candidate set of K beams, selecting, for communication with the network node, the candidate beam in the candidate set of K beams for which the reference signal received power measurements are highest.

According to a second aspect there is presented a user equipment for performing a UE-side beam selection procedure. The user equipment comprises processing circuitry. The processing circuitry is configured to cause the user equipment to receive, in candidate beam k, at least one downlink reference signal from a network node. Each of the at least one downlink reference signal is composed of orthogonal frequency-division multiplexing symbols. The processing circuitry is configured to cause the user equipment to associate the received at least one downlink reference signal with a reliability value. The processing circuitry is configured to cause the user equipment to determine, as a function of the reliability value and movement of the user equipment when receiving the at least one downlink reference signal, filter settings of a filter to be applied to the at least one received downlink reference signal. The processing circuitry is configured to cause the user equipment to filter the received at least one downlink reference signal according to the determined filter settings. The processing circuitry is configured to cause the user equipment to perform reference signal received power measurements on the filtered at least one received downlink reference signal. The processing circuitry is configured to cause the user equipment to, once the above steps have been performed for each candidate beam k, where k=1, . . . , K, in a candidate set of K beams, select, for communication with the network node, the candidate beam in the candidate set of K beams for which the reference signal received power measurements are highest.

According to a third aspect there is presented a computer program for performing a UE-side beam selection procedure, the computer program comprising computer program code which, when run on a user equipment, causes the user equipment to perform a method according to the first aspect.

According to a fourth aspect there is presented a computer program product comprising a computer program according to the third aspect and a computer readable storage medium on which the computer program is stored. The computer readable storage medium could be a non-transitory computer readable storage medium.

Advantageously, the disclosed UE-side beam selection procedure does not suffer from the issues disclosed above.

Advantageously, these aspects enable parameters of the UE-side beam selection procedure to be adapted according to current radio propagation environment parameters. In turn, this will improve the reliability of the UE-side beam selection and hence improve the uplink/downlink performance between the network node and the user equipment.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise.

The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to examples;

FIG. 2 schematically illustrates a beam management procedure according to examples;

FIG. 3 schematically illustrates path gain as a function of slot index according to an example;

FIG. 4 is a flowchart of methods according to embodiments;

FIG. 5 and FIG. 6 schematically illustrates SSBs according to embodiments;

FIG. 7 is a schematic diagram showing functional units of a user equipment according to an embodiment;

FIG. 8 is a schematic diagram showing functional modules of a user equipment according to an embodiment; and

FIG. 9 shows one example of a computer program product comprising computer readable storage medium according to an embodiment.

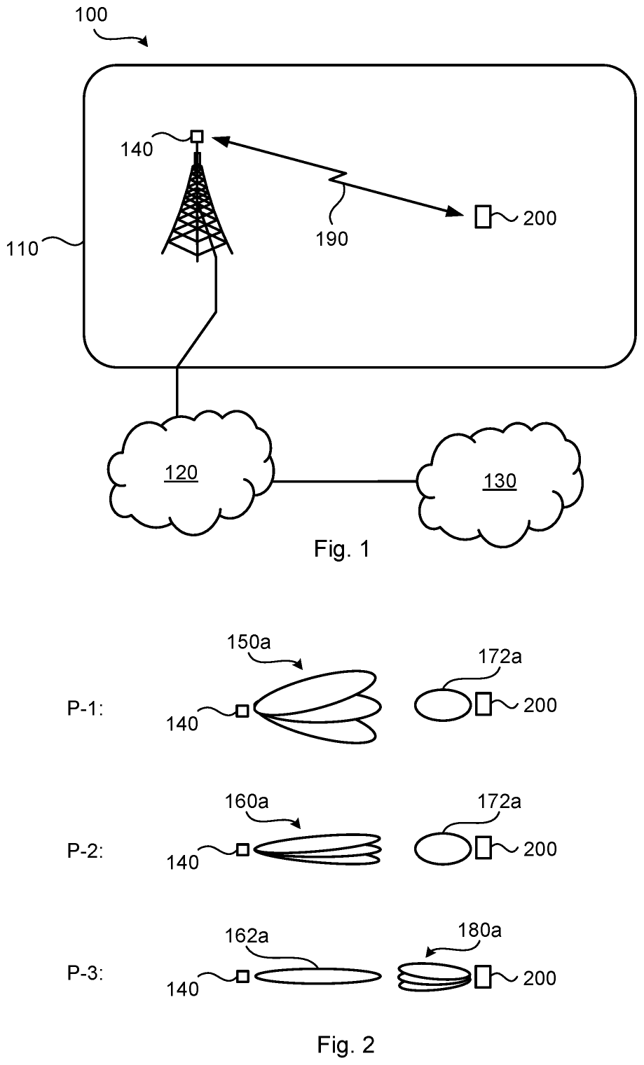

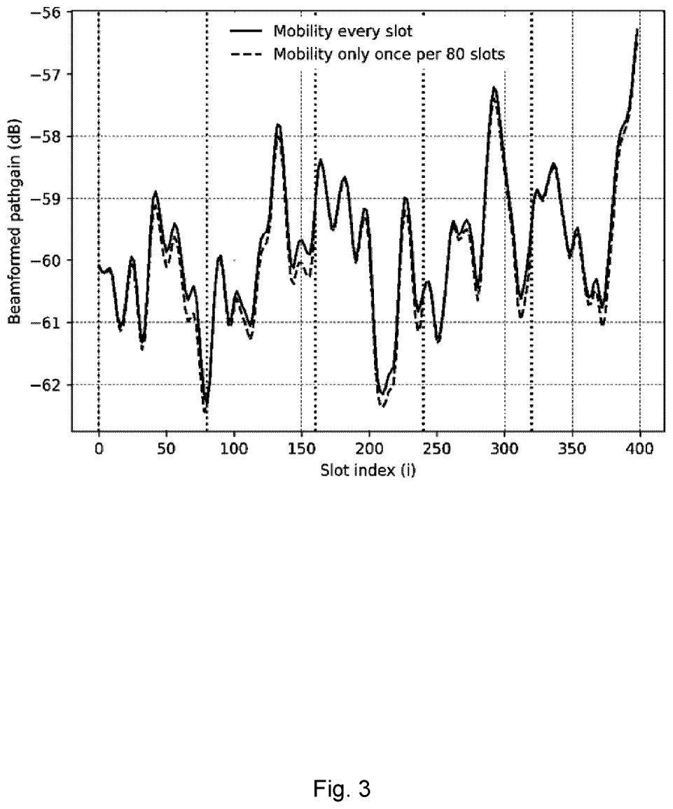

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

As noted above, there is still a need for an improved beam selection procedure.

The inventors of the herein disclosed embodiments have, for example, realized the following issues.

The coverage of certain types of downlink reference signals (such as SSBs) might become an issue at carrier frequencies above 100 GHz due to very short OFDM symbols (due to larger sub-carrier spacings). This might degrade existing UE-side beam selection procedures.

In good channel conditions it might be sufficient for the user equipment 200 to, per each candidate beam, perform RSRP measurements during only one or a few OFDM symbols, whereas in bad channel conditions the entire set of OFDM symbols per downlink reference signal might be needed for the RSRP measurements per candidate beam.

Due to bursty nature of the interference situations at such higher carrier frequencies (for example due to narrow candidate beams being used), it might be that the user equipment 200 receives some downlink reference signals with high inter-cell interference, causing un-reliable RSRP measurements due to low signal to interference plus noise ratio (SINR). This might degrade existing UE-side beam selection procedures.

Due to fast fading effects of the channels between the network node and the user equipment, RSRP measurements based on a single burst of downlink reference signals might degrade existing UE-side beam selection procedures. This is since the UE-side beam selection typically is assumed to identify a beam to be used on more long-term basis than the duration of the fast fading effects.

The quicker a user equipment 200 moves, or rotates, the quicker the beam selection should be updated.

The embodiments disclosed herein therefore relate to techniques for performing a UE-side beam selection procedure, addressing the above issues. In order to obtain such techniques there is provided a user equipment 200, a method performed by the user equipment 200, a computer program product comprising code, for example in the form of a computer program, that when run on a user equipment 200, causes the user equipment 200 to perform the method.

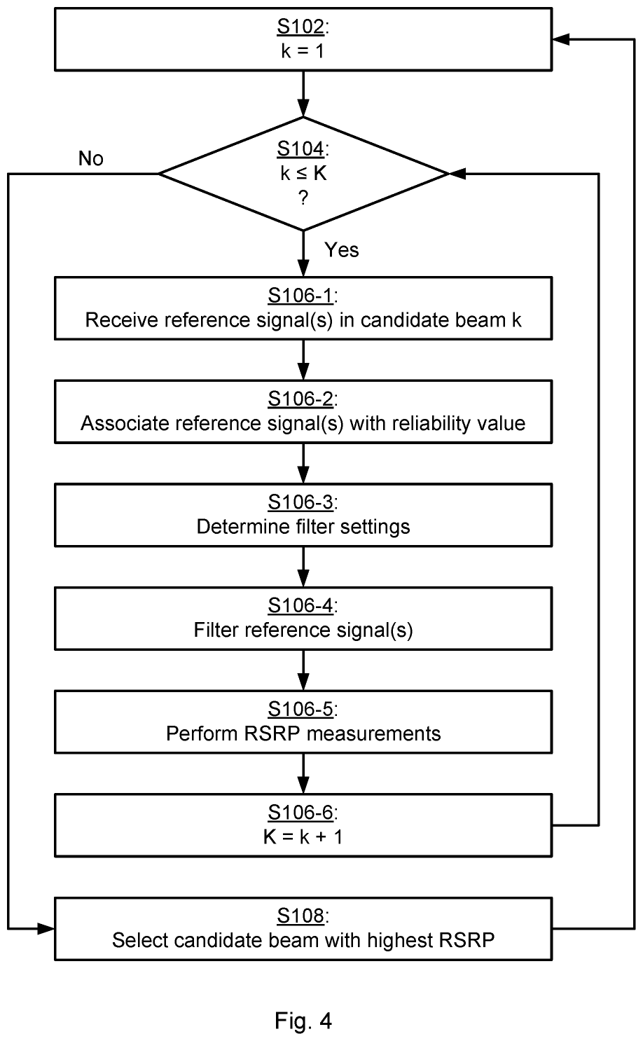

FIG. 4 is a flowchart illustrating embodiments of methods for performing a UE-side beam selection procedure. The methods are performed by the user equipment 200. The methods are advantageously provided as computer programs 920.

In general terms, at least some of the herein disclosed embodiments are based on that the user equipment 200, based on an estimated reliability value of received downlink reference signals and the movement of the user equipment 200, the user equipment 200 determines how to filter the received downlink reference signals measurements when determining which candidate beam to use for communication with the network node 140.

One run of the UE-side beam selection procedure comprises steps S102 to S108 to be performed for a candidate set of K beams 180a, where K≥2 is an integer. In this respect, steps S106-1 to S106-6 are performed for each candidate beam k, where k=1, . . . , K, in the candidate set of K beams 180a.

S102: The user equipment 200 initializes the UE-side beam selection procedure and sets k=1.

S104: The user equipment 200 checks whether k≤K or not. If yes, then steps S106-1 to S106-5 are performed for candidate beam k. If no, then step S108 is entered.

S106-1: The user equipment 200 receives, in candidate beam k, at least one downlink reference signal from a network node 140. Each of the at least one downlink reference signal is composed of orthogonal frequency-division multiplexing (OFDM) symbols.

S106-2: The user equipment 200 associates the received at least one downlink reference signal with a reliability value.

S106-3: The user equipment 200 determines, as a function of the reliability value and movement of the user equipment 200 when receiving the at least one downlink reference signal, filter settings of a filter to be applied to the at least one received downlink reference signal

S106-4: The user equipment 200 filters the received at least one downlink reference signal according to the determined filter settings.

S106-5: The user equipment 200 performs RSRP measurements on the filtered at least one received downlink reference signal.

Once steps S106-1 to S106-5 have been performed for candidate beam k, step S106-6 is entered and the value of k is incremented. That is, k=k+1. Step S104 is then entered again.

S108: The user equipment 200 selects, for communication with the network node 140, the candidate beam in the candidate set of K beams 180a for which the RSRP measurements are highest.

Step S102 can then be entered again once a new run of the UE-side beam selection procedure needs to be performed.

Embodiments relating to further details of performing a UE-side beam selection procedure as performed by the user equipment 200 will now be disclosed.

In some examples, the UE-side beam selection procedure is performed as part of a beam management procedure. In some examples, the UE-side beam selection procedure is performed as part of a P-3 sub-procedure, or is used as a substitute to the P-3 sub-procedure described above with reference to FIG. 2.

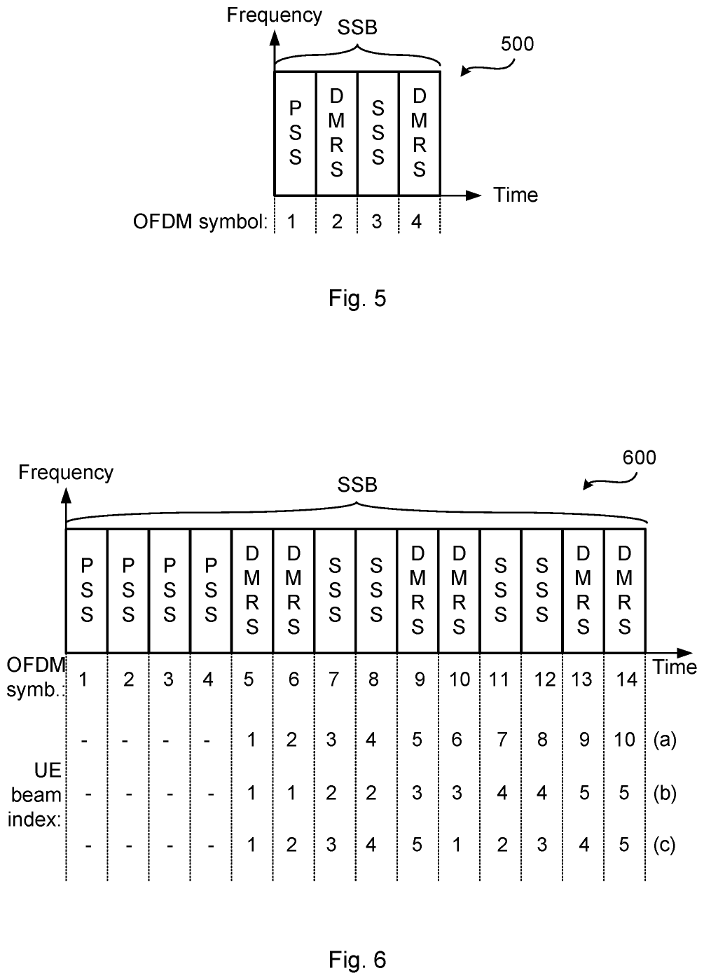

There could be different examples of downlink reference signals. In some examples, the at least one downlink reference signal is part of an SSB or a CSI-RS. Reference is here made to FIG. 5 and FIG. 6. FIG. 5 schematically illustrates a first example of an SSB 500. In FIG. 5 the SSB 500 is composed of a primary synchronization signal (PSS) in OFDM symbol 1, a demodulation reference signal (DMRS) in OFDM symbol 2, a secondary synchronization signal (SSS) in OFDM symbol 3, and a DMRS in OFDM symbol 4. FIG. 6 schematically illustrates a second example of an SSB 600. In FIG. 6 the SSB 600 is composed of a PSS in OFDM symbols 1, 2, 3, 4, a DMRS in OFDM symbols 5, 6, 9, 10, 13, 14, and an SSS in OFDM symbols 7, 8, 11, 12. It is here noted that in both SSBs 500, 600 the DMRS might be provided as part of a physical broadcast channel (PBCH). That is, the OFDM symbols comprising the DMRS might further comprise other information of the PBCH. FIG. 6 at (a), (b), and (c) illustrates different examples of in which candidate beam (as represented by a UE beam index) a certain part of the SSB 600 is to be received by the user equipment 200. In the illustrative example of FIG. 6 it might be assumed that the user equipment 200 has 10 available candidate beams to select from but the example can be generalized also for other numbers of available candidate beams. Examples with reference to (a), (b), and (c) of FIG. 6 with respect to how the SSB 600 can be exploited during the UE-side beam selection procedure will be disclosed below. In the examples (a), (b), and (c) only the SSS and the DMRS (in the PBCH) are used for the UE-side beam selection procedure. However, in other examples also the PSS is used. This might allow a larger number of candidate beams to be evaluated per SSB and/or more OFDM symbols to be used for evaluating each candidate beam.

Aspects of the reliability value will now be disclosed.

The reliability value might be pre-determined to the actual UE-side beam selection procedure, for example based on previous measurements (such as pathloss measurements) made by the user equipment 200, based on inter-cell interference estimations, based on reports (such as CSI reports) received by the user equipment 200, based on re-transmissions made between the network node 140 and the user equipment 200, etc. Particularly, in some embodiments, the reliability value is estimated from at least one of: link budget estimations for the at least one downlink reference signal, interference strength estimates, burstiness estimates of the interference, variations over time in the RSRP measurements. The link budget estimations might be based on noise level estimations and previous RSRP measurements. The variations over time in the RSRP measurements might be due to fast fading effects.

Further, the reliability value might be different for different types of reference signals (or part thereof) used for evaluating the candidate beams. Particularly, in some embodiments, the reliability value depends on what type of at least one reference signal is received and/or on what part of the at least one reference signal the RSRP measurements are performed.

Aspects of the movement of the user equipment 200 will now be disclosed.

There could be different types of movement. In some aspects, the movement pertains to rotational movement of the user equipment 200. In other aspects, the movement pertains to transversal movement of the user equipment 200. In yet other aspects, the movement pertains to a combined rotational and transversal movement of the user equipment 200. The movement of the user equipment 200 might be estimated based on accelerator measurements, inertial measurement unit (IMU) measurements, Doppler estimations, etc. for the user equipment 200.

Aspects of the filter settings and the RSRP measurements will now be disclosed.

As noted in step S106-1, each of the at least one downlink reference signal is composed of OFDM symbols.

In some aspects, multiple OFDM symbols are used to perform RSRP measurements per candidate beam k within a burst of reference signals. Particularly, in some embodiments, the filter settings pertain to for how many of the OFDM symbols the RSRP measurements are to be performed for candidate beam k.

Assume, for example, that the user equipment 200 has determined that it is moving/rotating slowly and that it has a low reliability value of its received downlink reference signals due to poor link budget of the downlink reference signals and/or that the user equipment 200 is affected by strong interference. Due to the low reliability value, the beam selection based on RSRP measurements becomes un-reliable. However to the slow rotation/movement, the beam selection update could be performed on a long timescale (i.e., less frequently) without any (notable) loss in performance. In one alternative, the user equipment 200 might improve the UE-side beam selection by combining measurements from two or more OFDM symbols of the same downlink reference signal for each evaluated candidate beam. Since two or more measurements are combined, the reliability value will be improved. That is, the reliability of the protocol layer 1 (L1) RSRP measurements, and hence also the UE-side beam selection, will be improved. Thus, in contrast to evaluating, say, 8 candidate beams for each received burst of downlink reference signals, the UE might only sweep through 4 candidate beams per burst. This means that two OFDM symbols of the downlink reference signal are received in each candidate beam. Assuming that eight beams still need to be evaluated, the user equipment 200 can thus select the candidate beam based on the two last bursts of downlink reference signals. By receiving two OFDM symbols with the same candidate beam in the same slot, the channel estimates (as used to calculate RSRP) can be coherently combined from the two OFDM symbols before a resulting RSRP is calculated. This will improve the reliability of the RSRP measurement. Particularly, in some embodiments, the RSRP measurements are performed based on channel estimates, and the filter settings pertain to coherently combining the channel estimates for the at least one downlink reference signal.

The number of OFDM symbols of a downlink reference signal used for calculating the RSRP per candidate beam can be determined based on how quick the user equipment 200 rotates, or moves, and the link budget of the downlink reference signal. For example, if the user equipment 200 has more or less fixed position, and the reliability value of the received downlink reference signal is relatively poor, RSRP measurements based on more than two OFDM symbols can be combined per candidate beam.

Reference is here made to FIG. 6(a). Here, one OFDM symbols is used per candidate beam and thus 10 candidate beam can be evaluated per each SSB. That is, one RSRP measurement is made per each candidate beam. For example, for the candidate beam with UE beam index 6 the RSRP measurement is made on the DMRS of OFDM symbol 10. FIG. 6(a) could represent an example where the user equipment 200 is rotating and/or moving at a comparatively high speed and has a comparatively high link budget. Reference is next made to FIG. 6(b). Here, two OFDM symbols are used per candidate beam and thus 5 candidate beams can be evaluated per each SSB. The user equipment 200 might perform independent beam sweeps per SSB. If the user equipment 200 has a total of 10 candidate beams to be evaluated, per SSB, candidate beams 1 to 5 can be evaluated in a first SSB burst, and candidate beams 6-10 can be evaluated in a second SSB burst. An SSB burst is transmitted typically every 20 ms and in each SSB burst, X SSBs are transmitted, where typically 1≤X≤64. This implies that, per SSB, half of the candidate beams can be evaluated in one SSB. For example, candidate beams with UE beam indices 1-5 can be evaluated in every odd SSB burst, and candidate beams with UE beam indices 6-10 can be evaluated in every even SSB burst. That is, two RSRP measurements are made per each candidate beam. For example, for the candidate beam with UE beam index 2 the RSRP measurements are made on the SSS of OFDM symbol 7 and the SSS of OFDM symbol 8. FIG. 6(b) could represent an example where the user equipment 200 is rotating and/or moving at a comparatively low speed and has a comparatively low link budget.

As in the example of FIG. 6, in some embodiments, the at least one downlink reference signal is part of an SSB or a burst of CSI-RSs, and all the OFDM symbols received per candidate beam k belong to one and the same SSB or burst of CSI-RSs. As in the example of FIG. 6, in some embodiments, different parts of one and the same SSB are received in different ones of the candidate beams. In some examples, if the user equipment 200 uses SSS, PSS and/or DMRS of the PBCH to calculate the RSRP during a UE-side beam selection procedure, the reliability value of the RSRP measurements might be different for the different signals. For example, for the PBCH, only every fourth sub-carrier might comprise a DMRS. So, if the same Energy Per Resource Element (EPRE) is used for the SSS and the DMRS of the PBCH, the total received power used to calculate the RSRP is higher for the SSS than for the DMRS of the PBCH. Hence, more reliable RSRP measurement might be determined for the SSS than for the DMRS of the PBCH for a single OFDM symbol. Therefore, the user equipment 200 might combine different number of OFDM symbols for an RSRP measurement of a candidate beam depending on which kind of reference signal (or part thereof, such as PBCH or SSS)) it uses to calculate the RSRP. Particularly, in some embodiments, the filter settings pertain to what type of at least one reference signal is received and/or on what part of the at least one reference signal the RSRP measurements are to be performed. For example, the user equipment 200 might even use one single OFDM symbol to calculate the RSRP for a candidate beam based on a downlink reference signal in the form of an SSS, whilst the user equipment 200 might use two OFDM symbols to calculate the RSRP for a candidate beam based on a downlink reference signal in the form of an DMRS of the PBCH. In similar way, the EPRE of the PSS might differ from the EPRE of the SSS. In this case the user equipment 200 might use different number of OFDM symbols to calculate RSRP for a candidate beam based on a downlink reference signal in the form of a PSS compared to a downlink reference signal in the form of an SSS. Further, the combination of measurements may be based on the energy per RSRP measurement.

In some examples, the user equipment 200 alternates between evaluating all available candidate beams and a subset of the candidate beams for different downlink reference signal bursts. For example, the user equipment 200 might for a first burst evaluate all available candidate beams and determine the M best candidate beams with highest RSRP. Then in a next beam sweep the user equipment 200 only evaluates these M candidate beams and combines the RSRP measurements with the RSRP measurements from the previous beam sweep when all the candidate beams were evaluated. This will increase the UE-side beam section reliability. For example, in every odd burst of downlink reference signals the user equipment 200 might evaluate all candidate beams but in every even burst of the downlink reference signals the user equipment 200 might only evaluate the M best candidate beams from the recent-most odd burst. In some examples, the user equipment 200 uses every L:th burst of the downlink reference signal to evaluates all the candidate beams, and the remaining bursts to evaluate only the best M candidate beams from the recent-most L:th burst. For example, in burst l the user equipment 200 evaluates all candidate beams, then in bursts l+1, l+2, . . . , l+L−1 only the M best candidate beams from burst l are evaluated (but, as above, RSRP measurements are combined for two or more bursts), and then in burst l+L all candidate beams are evaluated again, and so on. In some examples, when the user equipment 200 detects a sudden change in rotation speed, position, and/or a significant change in received power, the user equipment 200 will in the next burst of downlink reference signals evaluate all candidate beams.

In some examples, the user equipment 200 is equipped with antenna arrangements in the form of two or more panels. These panels might all point in the same direction or the panels might point in two or more directions, depending on the realization of the user equipment 200. Therefore, in some examples, the number of OFDM symbols used for the RSRP measurements per candidate beam varies from panel to panel. This could be advantageous if the user equipment 200 experiences different reliability values for the different panels (due to, for example, different link budget, different interference situation, etc.). Hence, for a first panel associated with a comparatively high reliability value the user equipment 200 might evaluate one candidate beam per OFDM symbol, whilst for a second panel associated with a comparatively low reliability value, the user equipment 200 might use multiple OFDM symbols per candidate beam when calculating the RSRP. In this way, the UE-side beam selection for the second panel will become more reliable, which e.g., could become important in case the BPL to the first panel gets blocked and the user equipment 200 therefore needs to switch panel to the second panel.

In some examples, the user equipment 200 spreads out the OFDM symbols used per candidate beam in time, in order to mitigate interference issues. Particularly, in some embodiments, the OFDM symbols belong to two different reference signals, and at least one intermediate reference signal is received in time between a first of the two different reference signals and a second of the two different reference signals. This at least one intermediate reference signal can be used for evaluating another candidate beam. Reference is here made to FIG. 6(c). As in FIG. 6(b), two OFDM symbols are used per candidate beam and thus 5 candidate beams can be evaluated per each SSB. If the user equipment 200 has a total of 10 candidate beams to be evaluated this implies that half of the candidate beams can be evaluated in one SSB. For example, candidate beams with UE beam indices 1-5 can be evaluated in every odd SSB burst, and candidate beams with UE beam indices 6-10 can be evaluated in every even SSB burst. That is, two RSRP measurements are made per each candidate beam. FIG. 6(c) differs from FIG. 6(b) in that the RSRP measurements per candidate beam are not made on adjacent OFDM symbols of the SSB. For example, for the candidate beam with UE beam index 2 the RSRP measurements are made on the DMRS of OFDM symbol 6 and the SSS of OFDM symbol 11. Hence, there is a gap of four OFDM symbols between two RSRP measurements corresponding to the same candidate beam. FIG. 6(c) also show that RSRP measurements per candidate beam can be combined for different types of signals (SSS and DMRS). Such RSRP measurements might be combined taking the different energy per type of signal into account. This can potentially improve the reliability of the RSRP measurements in presence of interference since it is likely that the interference comes in bursts of one or several sequential OFDM symbols. For example, with continued reference to FIG. 6, assume that the user equipment 200 experiences heavy interference in OFDM symbols 5, 6, 7, 8, which deteriorates the quality of the RSRP measurements for these OFDM symbols. If so, the example of FIG. 6(b) might yield un-reliable RSRP measurements for the candidate beams with UE beam indices 1 and 2 even though RSRP measurements are made on two OFDM symbols per candidate beam. For the example in FIG. 6(c) at least one OFDM symbol per candidate beam is not experiencing any interference.

In some aspects, as has already disclosed above, each downlink reference signal is transmitted as part of a reference signal burst. As will be further disclosed next, the user equipment 200 might then calculate the RSRP for each candidate beam k based on downlink reference signal transmitted in at least two reference signal bursts. Since the interference situation might differ between two adjacent reference signal bursts, and since basing the RSRP for each candidate beam k on downlink reference signal transmitted in at least two reference signal bursts might reduce fast fading effects, this could improve the diversity gain. Particularly, in some embodiments, the OFDM symbols belong to at least two different reference signals, where each of the at least two downlink reference signals is part of a respective SSB burst or CSI-RS burst.

In some examples, for each candidate beam k, the user equipment 200 calculates the RSRP for a downlink reference signal received during reference signal burst N−1 (denoted RSRP_{k,N-1}) and the RSRP for a downlink reference signal received during reference signal burst N (denoted RSRP_{k,N}), and then calculate the average RSRP (denoted RSRP_{k,average}) over these two bursts by the following calculation, which can be performed in either linear or logarithmic scale:

$${RSRP}_{k , average} = ( {RSRP}_{k , N} + {RSRP}_{k , N - 1} ) / 2$$

The user equipment 200 then compares the computed RRSRP_{k,average} for each candidate beam k and selects the candidate beam k for which RSRP_{k,average} is highest.

In some examples, different weight factors are applied to the RSRP measurements made for different bursts. A newer RSRP measurement (i.e., an RSRP measurement made for a more recently received downlink reference signal) can thereby be weighted higher than an older RSRP measurement (i.e., an RSRP measurement made for a less recently received downlink reference signal) when calculating the average RSRP. The following calculation, which can be performed in either linear or logarithmic scale, provides an example of this:

$${RSRP}_{k , average} = {a}_{0} {RSRP}_{k , N} + ( 1 - {a}_{0} ) {RSRP}_{k , N - 1}$$

Here, the parameter 0<a₀≤1 is a weight factor. Particularly, in some embodiments, the filter settings pertain to a respective weight factor to be applied to each of the at least two downlink reference signals when being filtered.

In the two examples above, the average RSRP for candidate beam k is calculated for downlink reference signals received during the two recent most reference signal bursts (i.e., burst N and burst N−1). In general terms, the average RSRP for candidate beam k might be calculated for downlink reference signals received during the M most recent reference signal bursts, where M≥2 is an integer. The value of M thus defines for how many downlink reference signals the RSRP measurements are to be performed for candidate beam k.

Further in this respect, the slower the user equipment 200 rotates (i.e., the slower the movement is) and the worse the reliability value is, the more reference signal bursts are used to calculate RSRP_{k,average} (i.e., the more filtering over time is performed). That is, the value of M can be set as function of the movement of the user equipment 200 and the reliability value. Particularly, in some embodiments, the filter settings pertain to for how many of the SSB bursts or CSI-RS bursts the RSRP measurements are to be performed for candidate beam k.

The RSRP measurement made for each received downlink reference signal can then be weighted with its own weight factor aₘ, where o<m≤M−1. In some examples, all weight factors should sum to unity. Particularly, in some embodiments, according to the filter settings, the more recent in time one of the at least two downlink reference signals is received, the higher the value of the weight factor that is applied to this one of the at least two downlink reference signals. This implies that a₀>a₁> . . . >a_{M-1}.

Further, in some embodiments, according to the filter settings, the higher the reliability value is, the higher the value is of the weight factor that is applied to the most recently in time received one of the at least two downlink reference signals, and the lower the value is of the weight factor that is applied to the least recently in time received one of the at least two downlink reference signals.

In this way, a₀ can be proportional to the reliability value (although, as specified above, 0<a₀≤1).

Any combination is possible where the user equipment 200 uses both two or more OFDM symbols to perform RSRP measurements within an SSB (or CSI-RS) burst and over multiple SSB (or CSI-RS) bursts to determine a final RSRP value per candidate beam, which is then used to select a one of the candidate beams. In one example, the when the user equipment 200 uses two OFDM symbols within one SSB (or CSI-RS) burst to calculate an RSRP value per candidate beam, then combines the RSRP values from two different SSB (or CSI-RS) burst, and uses the resulting combined RSRP value to select one of the candidate beams.

Resetting of the filter settings will be disclosed next.

In some aspects, when the user equipment 200 detects a sudden change in movement, position, and/or a significant change in the RSRP from one RSRP measurement to the next, the filter settings are reset. Particularly, in some embodiments, the filter settings are determined to take a default value when a rate of change of the reliability value is above a reliability change threshold and/or a rate of change of the movement of the user equipment 200 is above a rotation speed change threshold. Previously made RSRP measurements might thereby be discarded such that the candidate beam selection only is based on one or more downlink reference signals of the recent-most reference signal burst.

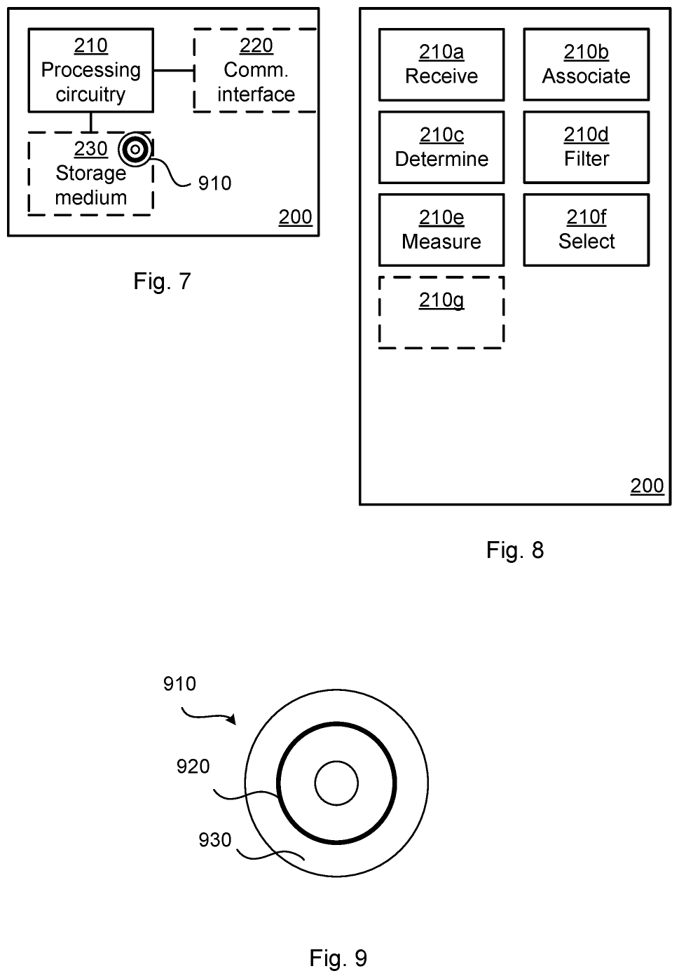

FIG. 7 schematically illustrates, in terms of a number of functional units, the components of a user equipment 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 910 (as in FIG. 9), e.g. in the form of a storage medium 230. The processing circuitry 210 may further be provided as at least one application specific integrated circuit (ASIC), or field programmable gate array (FPGA).

Particularly, the processing circuitry 210 is configured to cause the user equipment 200 to perform a set of operations, or steps, as disclosed above. For example, the storage medium 230 may store the set of operations, and the processing circuitry 210 may be configured to retrieve the set of operations from the storage medium 230 to cause the user equipment 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The user equipment 200 may further comprise a communications interface 220 at least configured for communications with other entities, functions, nodes and devices, such as the network node 140. As such the communications interface 220 may comprise one or more transmitters and receivers, comprising analogue and digital components. The processing circuitry 210 controls the general operation of the user equipment 200 e.g. by sending data and control signals to the communications interface 220 and the storage medium 230, by receiving data and reports from the communications interface 220, and by retrieving data and instructions from the storage medium 230. Other components, as well as the related functionality, of the user equipment 200 are omitted in order not to obscure the concepts presented herein.

FIG. 8 schematically illustrates, in terms of a number of functional modules, the components of a user equipment 200 according to an embodiment. The user equipment 200 of FIG. 8 comprises a number of functional modules; a receive module 210a configured to perform step S106-1, an associate module 210b configured to perform step S106-2, a determine module 210c configured to perform step S106-3, a filter module 210d configured to perform step S106-4, a measure module 210e configured to perform step S106-5, and a select module 210f configured to perform step S108. The user equipment 200 of FIG. 8 may further comprise a number of optional functional modules, as represented by functional module 210g. In general terms, each functional module 210a:210g may in one embodiment be implemented only in hardware and in another embodiment with the help of software, i.e., the latter embodiment having computer program instructions stored on the storage medium 230 which when run on the processing circuitry makes the user equipment 200 perform the corresponding steps mentioned above in conjunction with FIG. 8. It should also be mentioned that even though the modules correspond to parts of a computer program, they do not need to be separate modules therein, but the way in which they are implemented in software is dependent on the programming language used. Preferably, one or more or all functional modules 210a:210g may be implemented by the processing circuitry 210, possibly in cooperation with the communications interface 220 and/or the storage medium 230. The processing circuitry 210 may thus be configured to from the storage medium 230 fetch instructions as provided by a functional module 210a:210g and to execute these instructions, thereby performing any steps as disclosed herein.

FIG. 9 shows one example of a computer program product 910 comprising computer readable storage medium 930. On this computer readable storage medium 930, a computer program 920 can be stored, which computer program 920 can cause the processing circuitry 210 and thereto operatively coupled entities and devices, such as the communications interface 220 and the storage medium 230, to execute methods according to embodiments described herein. The computer program 920 and/or computer program product 910 may thus provide means for performing any steps as herein disclosed.

In the example of FIG. 9, the computer program product 910 is illustrated as an optical disc, such as a CD (compact disc) or a DVD (digital versatile disc) or a Blu-Ray disc. The computer program product 910 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 920 is here schematically shown as a track on the depicted optical disk, the computer program 920 can be stored in any way which is suitable for the computer program product 910.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for performing a user equipment (UE) side (UE-side) beam selection procedure, the method being performed by a UE, the UE-side beam selection procedure comprising:
for each candidate beam k, where k=1, . . . , K, in a candidate set of K beams:
receiving, in candidate beam k, a downlink reference signal from a network node, wherein the downlink reference signal is composed of orthogonal frequency-division multiplexing (OFDM) symbols;
associating the downlink reference signal with a reliability value;
determining, as a function of the reliability value and movement of the user equipment when receiving the downlink reference signal, filter settings of a filter to be applied to the received downlink reference signal;
filtering the received downlink reference signal according to the determined filter settings; and
performing reference signal received power measurements on the filtered downlink reference signal; and
selecting, for communication with the network node, the candidate beam in the candidate set of K beams for which the reference signal received power measurements are highest.

2. The method of claim 1, wherein the filter settings pertain to for how many of the OFDM symbols the reference signal received power measurements are to be performed for candidate beam k.

3. The method of claim 1, wherein the filter settings pertain to what type of reference signal is received and/or on what part of the reference signal the reference signal received power measurements are to be performed.

4. The method of claim 1, wherein the downlink reference signal is part of a synchronization signal block (SSB) or a channel state information reference signal (CSI-RS), and wherein all the OFDM symbols received per candidate beam k belong to one and the same SSB or CSI-RS.

5. The method of claim 4, wherein different parts of one and the same SSB are received in different ones of the candidate beams.

6. The method of claim 1, wherein the reference signal received power measurements are performed based on channel estimates, and wherein the filter settings pertain to coherently combining the channel estimates for the downlink reference signal.

7. The method of claim 1, wherein the OFDM symbols belong to two different reference signals, and wherein at least one intermediate reference signal is received in time between a first of the two different reference signals and a second of the two different reference signals.

8. The method of claim 1, wherein the OFDM symbols belong to at least two different reference signals, and wherein each of the at least two downlink reference signals is part of a respective synchronization signal block (SSB) or channel state information reference signal (CSI-RS).

9. The method of claim 8, wherein the filter settings pertain to for how many of the SSBs or CSI-RSs the reference signal received power measurements are to be performed for candidate beam k.

10. The method of claim 8, wherein the filter settings pertain to a respective weight factor to be applied to each of the at least two downlink reference signals when being filtered.

11. The method of claim 10, wherein, according to the filter settings, the more recent in time one of the at least two downlink reference signals is received, the higher the value of the weight factor that is applied to said one of the at least two downlink reference signals.

12. The method of claim 10, wherein, according to the filter settings, the higher the reliability value is, the higher the value is of the weight factor that is applied to the most recently in time received one of the at least two downlink reference signals, and the lower the value is of the weight factor that is applied to the least recently in time received one of the at least two downlink reference signals.

13. The method of claim 1, wherein the filter settings are determined to take a default value when a rate of change of the reliability value is above a reliability change threshold and/or a rate of change of the movement of the user equipment is above a rotation speed change threshold.

14. The method of claim 1, wherein the reliability value is estimated from at least one of: link budget estimations for the downlink reference signal, interference strength estimates, burstiness estimates of the interference, variations over time in the reference signal received power measurements.

15. The method of claim 1, wherein the reliability value depends on what type of at least one reference signal is received and/or on what part of the at least one reference signal the reference signal received power measurements are performed.

16. A user equipment (UE) for performing a UE-side beam selection procedure, the (UE) comprising:
a receiver; and
processing circuitry, the processing circuitry being configured to cause the user equipment to:
for each candidate beam k, where k=1, . . . , K, in a candidate set of K beams:
receive, in candidate beam k, at least one downlink reference signal from a network node, wherein each of the downlink reference signal is composed of orthogonal frequency-division multiplexing, OFDM, symbols;
associate the downlink reference signal with a reliability value;
determine, as a function of the reliability value and movement of the user equipment when receiving the downlink reference signal, filter settings of a filter to be applied to the received downlink reference signal;
filter the received downlink reference signal according to the determined filter settings; and
perform reference signal received power measurements on the filtered downlink reference signal; and
select, for communication with the network node, the candidate beam in the candidate set of K beams for which the reference signal received power measurements are highest.

17. The user equipment of claim 16, wherein the filter settings pertain to for how many of the OFDM symbols the reference signal received power measurements are to be performed for candidate beam k.

18. A computer program for performing a UE-side beam selection procedure, the computer program comprising computer code which, when run on processing circuitry of a user equipment, causes the user equipment to perform a UE-side beam selection procedure comprising:
for each candidate beam k, where k=1, . . . , K, in a candidate set of K beams:
receiving, in candidate beam k, a downlink reference signal from a network node, wherein the downlink reference signal is composed of orthogonal frequency-division multiplexing (OFDM) symbols;
associating the downlink reference signal with a reliability value;
determining, as a function of the reliability value and movement of the user equipment when receiving the downlink reference signal, filter settings of a filter to be applied to the received downlink reference signal;
filtering the received downlink reference signal according to the determined filter settings; and
performing reference signal received power measurements on the filtered downlink reference signal; and
selecting, for communication with the network node, the candidate beam in the candidate set of K beams for which the reference signal received power measurements are highest.

19. (canceled)
